(19) United States
(12) Patent Application Publication
(10) Pub. No.: US 2026/0266986 A1
(43) Pub. Date: Sep. 10, 2026

(54) RADAR APPARATUS, SYSTEM, AND METHOD

(71) Applicant: MOBILEYE VISION TECHNOLOGIES LTD., Jerusalem (IL)

(72) Inventors: Daniel GUDINETSKY, Givatayim (IL); Moshe TEPLITSKY, Tel-Aviv (IL)

(73) Assignee: MOBILEYE VISION TECHNOLOGIES LTD., Jerusalem (IL)

(21) Appl. No.: 19/471,396

(22) PCT Filed: Apr. 3, 2024
(86) PCT No.: PCT/IB2024/053256

§ 371 Date: Oct. 1, 2025

Related U.S. Application Data
(60) Provisional application No. 63/494,237, filed on Apr. 5, 2023.
(60) Provisional application No. 63/556,750, filed on Feb. 22, 2024.

(51) Int. Cl. G01S 13/931; G01S 13/58

(52) U.S. Cl. CPC G01S 13/931; G01S 13/584

(57) ABSTRACT

For example, a processor may be configured to identify one or more sets of virtual antenna values corresponding to one or more sets of overlapping virtual antennas, respectively. For example, a set of virtual antenna values corresponding to a set of overlapping virtual antennas may include a first virtual antenna value corresponding to a first virtual antenna, and a second virtual antenna value corresponding to a second virtual antenna. For example, the first virtual antenna may be based on a combination of a first Transmit (Tx) antenna and a first Receive (Rx) antenna, and the second virtual antenna may be based on a combination of a second Tx antenna and a second Rx antenna. For example, the processor may determine a plurality of adjusted virtual antenna values by adjusting a plurality of second-Tx-based virtual antenna values based on the one or more sets of virtual antenna values.

### CROSS REFERENCE

This application claims the benefit of, and priority from, US Provisional Patent Application No. 63/494,237 entitled “RADAR APPARATUS, SYSTEM, AND METHOD”, filed Apr. 5, 2023, and U.S. Provisional Patent Application No. 63/556,750 entitled “RADAR APPARATUS, SYSTEM, AND METHOD”, filed Feb. 22, 2024, the entire disclosures of which are incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of an antenna array and an overlapped virtual antenna array based on the antenna array, which may be implemented in accordance with some demonstrative aspects.

FIG. 11 is a schematic illustration of signals of a 2×4 Multiple-Input Multiple-Output (MIMO) antenna array, which may be implemented in accordance with some demonstrative aspects.

FIG. 12 is a schematic illustration of graphs depicting phases of virtual antenna elements of a virtual antenna, to illustrate one or more technical aspects, which may be addressed in accordance with some demonstrative aspects.

FIG. 13 is a schematic illustration of a system in accordance with some demonstrative aspects.

FIG. 14 is a schematic illustration of simulation results of an azimuth performance and an elevation performance, in accordance with some demonstrative aspects.

FIG. 15A and FIG. 15B are a schematic illustration of graphs depicting simulation results of a point cloud with a multipath phase correction and without the multipath phase correction, respectively, in accordance with some demonstrative aspects.

FIG. 16 is a schematic flow-chart illustration of a method of processing Range-Doppler (RD) information, in accordance with some demonstrative aspects.

FIG. 17 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like. The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

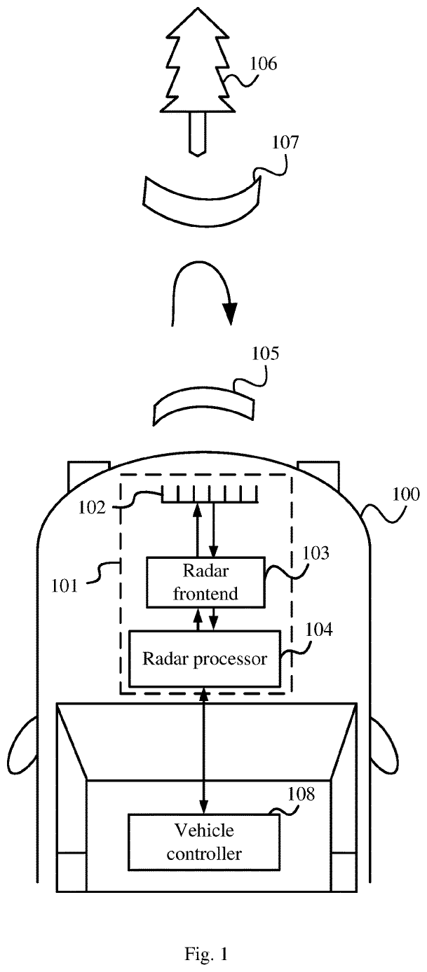

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

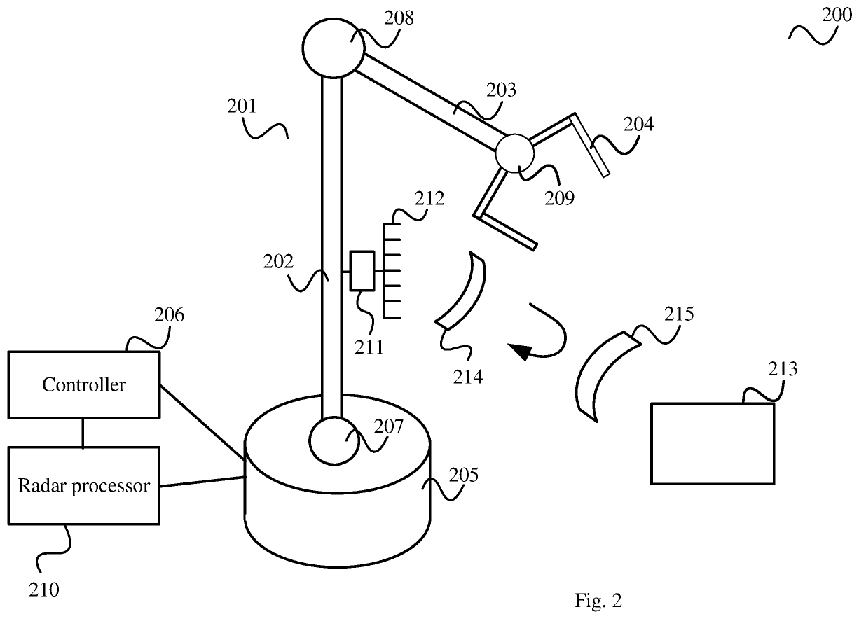

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

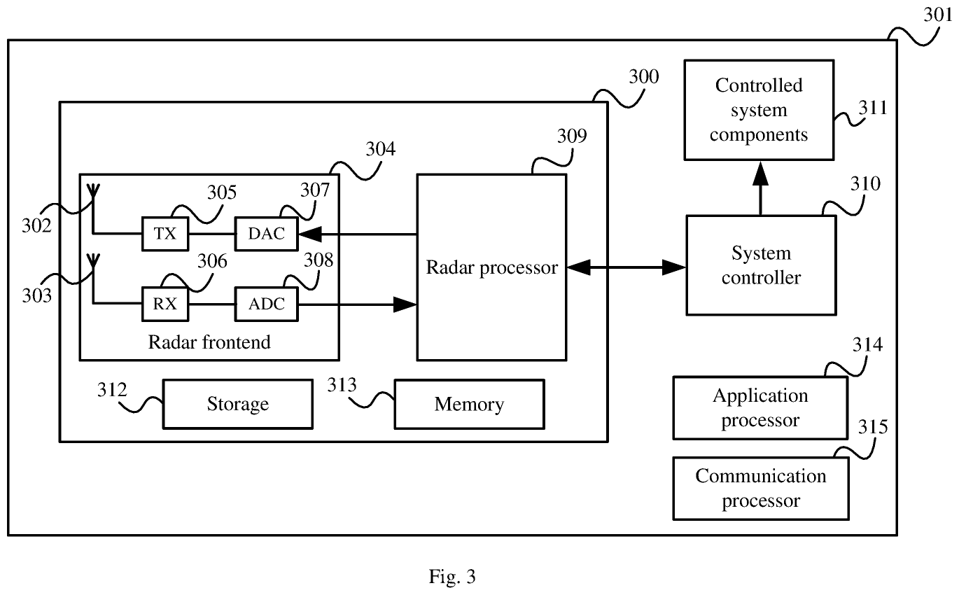

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g. a motor, a brake, steering, and the like, e.g. by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

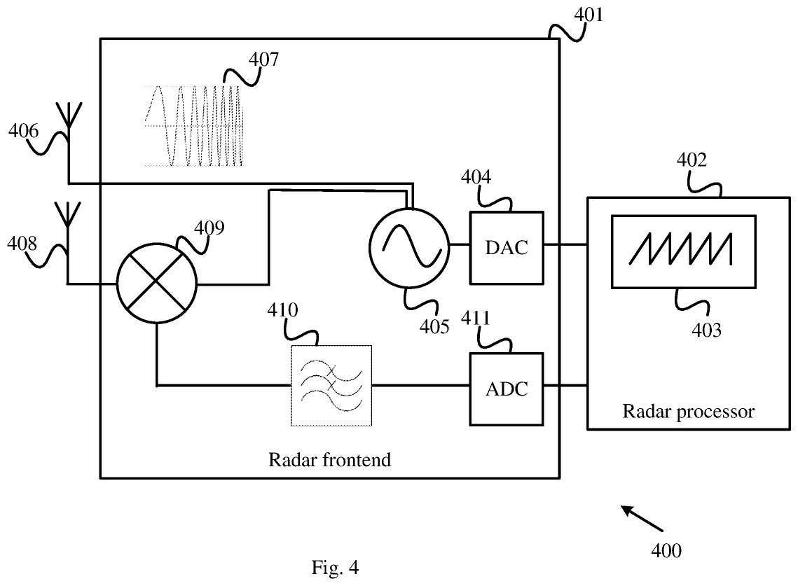

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, a radar device may be configured to utilize radio transmit signals having a form of chirps, e.g., chirps 407, for example, according to a chirp modulation, e.g., as described below.

In other aspects, the radar device may be configured to utilize radio transmit signals configured according to a Phase Modulation (PM), a digital modulation, an OFDM modulation, and/or any other suitable type of modulation.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

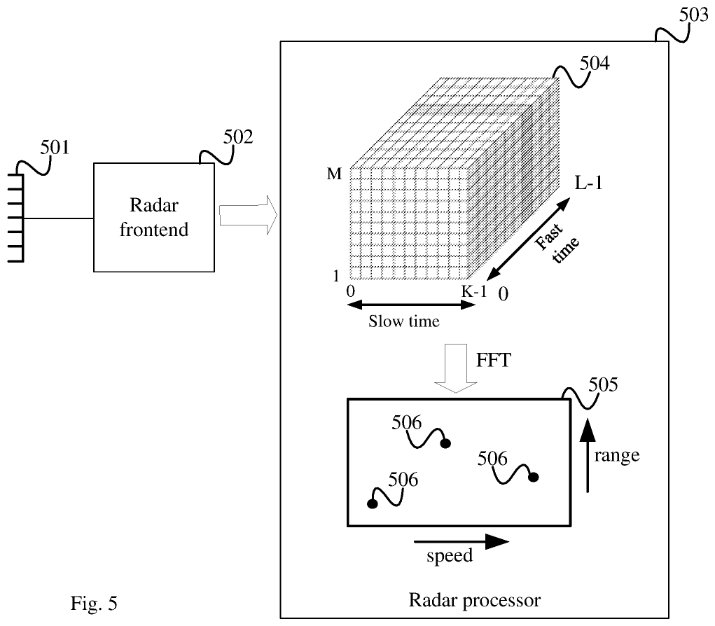

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time” direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time” direction of the data cube 504.

In some demonstrative aspects, processor 504 may be configured to determine the range values, Doppler values, and/or Angle of Arrival (AoA) values, e.g., Azimuth values and/or Elevation values, for example, based on FFT techniques, e.g., as described below.

In other aspects, processor 504 may be configured to determine the range values, Doppler values, and/or Angle of Arrival (AoA) values, e.g., Azimuth values and/or Elevation values, for example, based on Super-Resolution (SR) techniques, and/or any other suitable processing technique.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

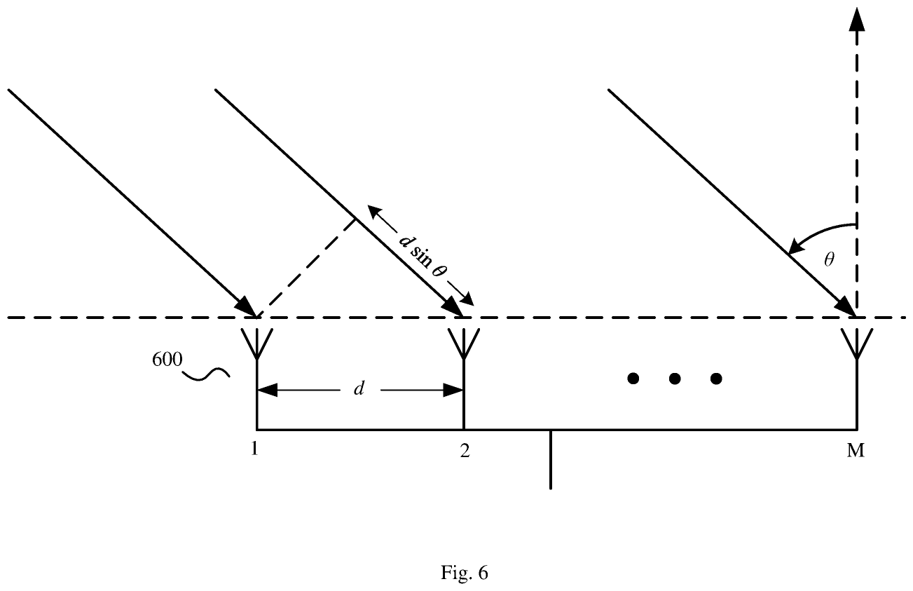

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

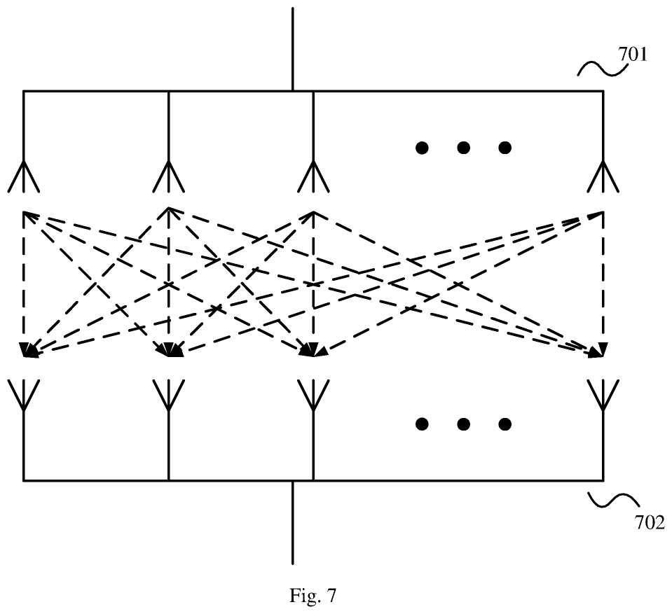

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

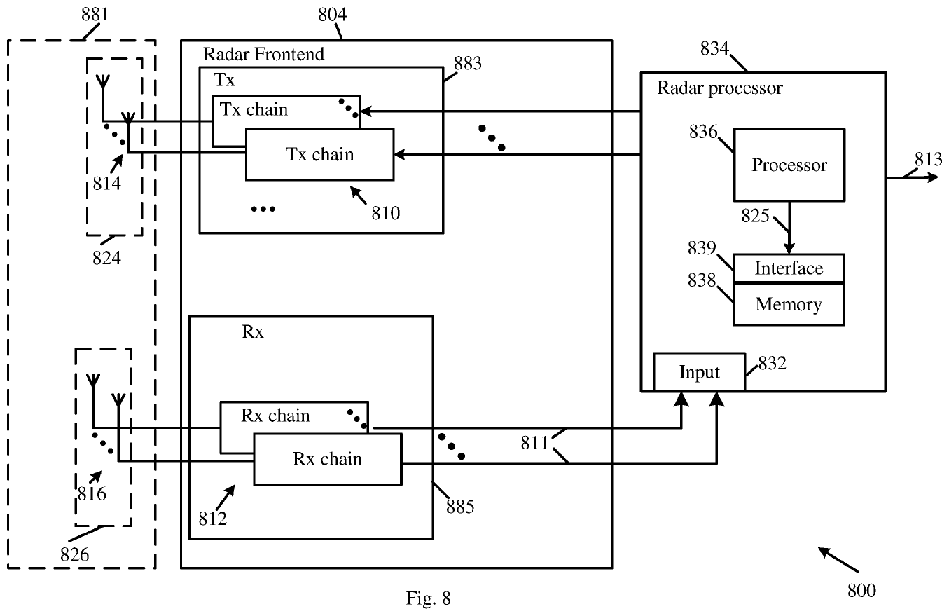

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, input 832 may include any suitable input interface, input unit, input module, input component, input circuitry, memory interface, memory access unit, memory reader, digital memory unit, bus interface, processor interface, or the like, which may be capable of receiving the radar input data from a memory, a processor, and/or any other suitable component to provide the radar input data.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, SNR estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

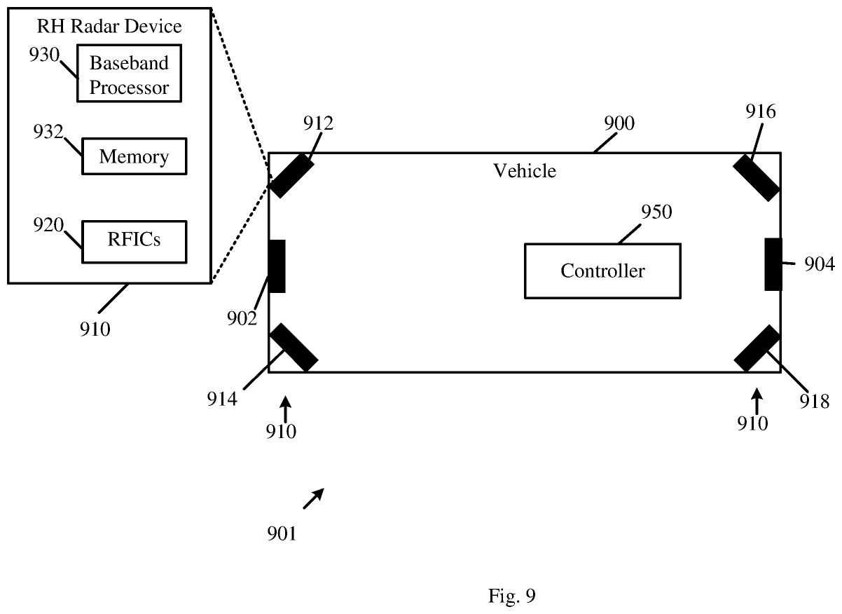

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to implement one or more operations and/or functionalities of a multipath detection and mitigation mechanism, e.g., as described below.

In some demonstrative aspects, in some use cases and/or scenarios, electromagnetic propagation in complex environments may generate a multipath effect, which may result in signals communicated by a radar system to have a different angle of departure versus an angle of arrival. For example, the multipath effect may lead to a degraded azimuth and/or elevation resolution, and/or to a degraded dynamic range performance.

In some demonstrative aspects, a radar device, e.g., as described above with reference to FIGS. 1-9, may be configured to implement one or more operations and/or functionalities of a multipath detection and mitigation mechanism, which may be configured to utilize an overlapped virtual array geometry, e.g., as described below.

In some demonstrative aspects, the multipath detection and mitigation mechanism may be implemented, for example, using an overlapped virtual antenna array, e.g., as described below.

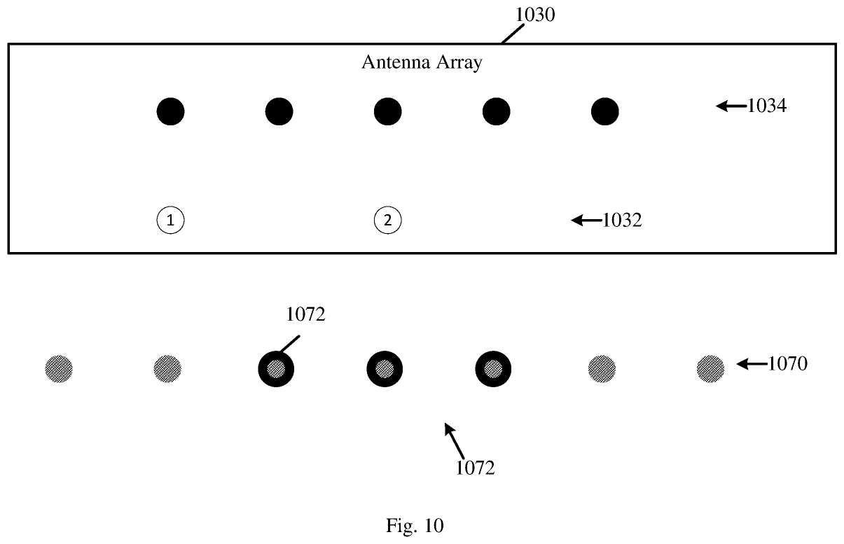

Reference is made to FIG. 10, which schematically illustrates an antenna array (“physical antenna array”) 1030 and an overlapped virtual antenna array 1070 based on the antenna array 1030, which may be implemented in accordance with some demonstrative aspects.

As shown in FIG. 10, antenna array 1030 may include a 2×5 MIMO antenna array.

For example, as shown in FIG. 10, antenna array 1030 may include five Rx antennas 1034 arranged along an Rx array, and two Tx antennas 1032, e.g., including a first Tx antenna (1) and a second Tx antenna (2).

For example, as shown in FIG. 10, a distance between the first Tx antenna (1) and the second Tx antenna (2) may be shorter than a length of the Rx array.

In other aspects, antenna array 1030 may include any other count of Tx antenna elements, any other count of Rx antenna elements, and/or any other arrangement of the Tx antenna elements and/or the Rx antenna elements.

In some demonstrative aspects, overlapped virtual antenna array 1070 may include one or more sets 1072 of overlapped virtual antennas (antenna elements), which may have substantially overlapping locations.

For example, as shown in FIG. 10, virtual antenna array 1070 may include three sets 1072 of overlapped virtual antennas.

For example, a set 1072 of overlapped virtual antennas may include a plurality of substantially overlapping virtual antennas, e.g., at substantially a same virtual location.

For example, a set 1072 of overlapped antennas may include a first virtual antenna, which may be based on a combination of the first Tx antenna (1) and a first Rx antenna 1034, and a second virtual antenna, which may be based on a combination of the second Tx antenna (2) and a second Rx antenna 1034.

In some demonstrative aspects, for example, in some use cases and/or scenarios, there may be one or more technical issues to be addressed, for example, when implementing an antenna array, e.g., including Tx antenna and Rx antennas, which builds a virtual antenna array with overlapped elements, for example, to deal with a multipath effect, e.g., in an azimuth direction. For example, implementing the virtual antenna array with overlapped elements may result in a reduced dynamic range near multipath targets. For example, the multipath targets may hide a real target, e.g., a smaller target, in the vicinity of the multipath targets. For example, implementing the virtual antenna array with overlapped elements may provide a relatively low resolution separation in multipath cases.

In some demonstrative aspects, a multipath detection and mitigation mechanism may be configured to utilize overlapped virtual antenna sets 1072 of the overlapped virtual antenna array 1070, for example, to provide a technical solution to mitigate a phase distortion in multipath cases, e.g., as described below.

In some demonstrative aspects, the multipath detection and mitigation mechanism may be configured to utilize the overlapped virtual antenna sets 1072 of the overlapped virtual antenna array 1070, for example, to estimate and compensate the phase distortion, for example, in multipath cases, e.g., as described below.

In some demonstrative aspects, the multipath detection and mitigation mechanism may be implemented for processing signals communicated by a MIMO radar antenna, e.g., as described below.

For example, in a beamforming system, e.g., without loss of generativity, assuming a system including a single transmitter and multiple receivers, e.g., a Single Input Multiple Output (SIMO) system, a number of Rx antennas may be doubled, for example, in order to double an angular resolution of the SIMO system, e.g., to achieve a half resolution bin. For example, in a MIMO system, the same result may be achieved, for example, with a double number of Tx antennas.

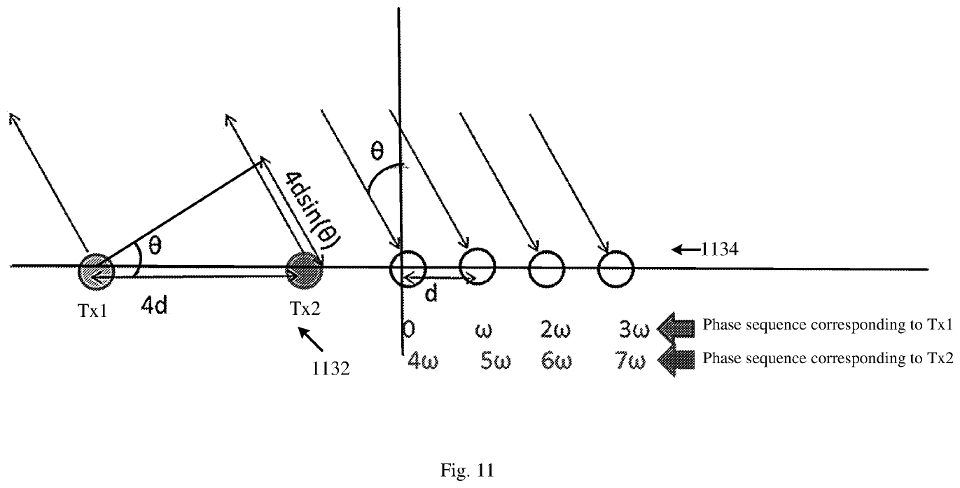

Reference is made to FIG. 11, which schematically illustrates signals of a 2×4 MIMO antenna array 1100, which may be implemented in accordance with some demonstrative aspects.

For example, as shown in FIG. 11, the 2×4 MIMO antenna array 1100 may include two Tx antennas 1132, for example, including a first Tx antenna 1132, denoted Tx1, and a second Tx antenna 1132, denoted Tx2.

For example, as shown in FIG. 11, the 2×4 MIMO antenna array 1100 may include four Rx antennas 1134.

For example, in the 2×4 MIMO system 1100, a first transmission from the first antenna Tx1 may result in a first set of phases of [0 ω 2ω 3ω ] at the four Rx antennas 1132, respectively, e.g., with a first Rx antenna 1134 serving as a reference.

For example, in the 2×4 MIMO system 1100, a second transmission from the second antenna Tx2 may result in a second set of phases of [4ω 5ω 6ω 7ω ] at the four Rx antennas 1132, respectively, e.g., with the first Rx antenna 1134 serving as a reference.

For example, the second Tx antenna Tx2 may be placed at a distance of 4d from the first Tx antenna Tx1, e.g., wherein d denotes a distance between consecutive Rx antennas 1134. According to this example, any signal emanating from the second Tx antenna Tx2 may traverse an additional path having a length 4d sin(θ), e.g., compared to a signal from the first antenna Tx1. Correspondingly, a signal at an Rx antenna 1134, a signal at each Rx antenna 1134, may see an additional phase-shift of 4ω, for example, with regard to a signal from the first antenna Tx1 received at the same Rx antenna 1134

For example, the phase of the signal at the four Rx antennas 1134, e.g., due to the second transmission from the second antenna Tx2, may be represented by the set of phases [4ω 5ω 6ω 7ω ].

For example, concatenating the phase sequences at the four Rx antennas 1134, e.g., due to transmissions from the first antenna Tx1 and the second antenna Tx2, may result in a sequence of phases [0 ω 2ω 3ω 4ω 5ω 6ω 7ω ].

For example, the sequence of phases [0 ω 2ω 3ω 4ω 5ω 6ω 7ω ] may be the same as a sequence of phases seen by a 1×8 SIMO system.

For example, it can be said that the 2×4 MIMO system 1100 may synthesize a virtual array of eight Rx antennas and one Tx antenna implied.

For example, with an antenna array including N_{Tx} transmit antennas and N_{Rx} receive antennas, one can generate, e.g., while utilizing proper antenna placement, a virtual antenna array of N_{Tx}×N_{Rx} virtual antennas.

For example, MIMO radar techniques may be employed, for example, to provide a technical solution to support an increase, e.g., a multiplicative increase, in a number of virtual antennas.

For example, the increased number of virtual antennas may be implemented to provide a technical solution to support an improvement in an angular resolution.

For example, using pₘ to denote coordinates of an m-th Tx antenna (m=0, 1, . . . . N_{Tx}), and using qₙ to denote coordinates of an n-th Rx antenna (n=0, 1, 2, . . . . N_{Rx}), a location of a virtual antenna, based on the m-th Tx antenna and the n-th Rx antenna, may be computed as pₘ+qₙ, e.g., for all possible values of m and n.

For example, the location of the virtual antenna may be represented in a compact form, e.g., as follows:

$$r = p ⊗ q$$

wherein r denotes coordinates of the elements in the virtual array, which is a result of a convolution of coordinates of the m-th Tx and the n-th Rx array elements.

In some demonstrative aspects, a MIMO radar may suffer from phase shift in a virtual array, for example, as a result of a multipath effect, e.g., causing a different angle of arrival versus an angle of departure, e.g., as described below.

For example, the multipath effect may distort an azimuth spectrum and/or an elevation spectrum of the MIMO radar, e.g., as described below.

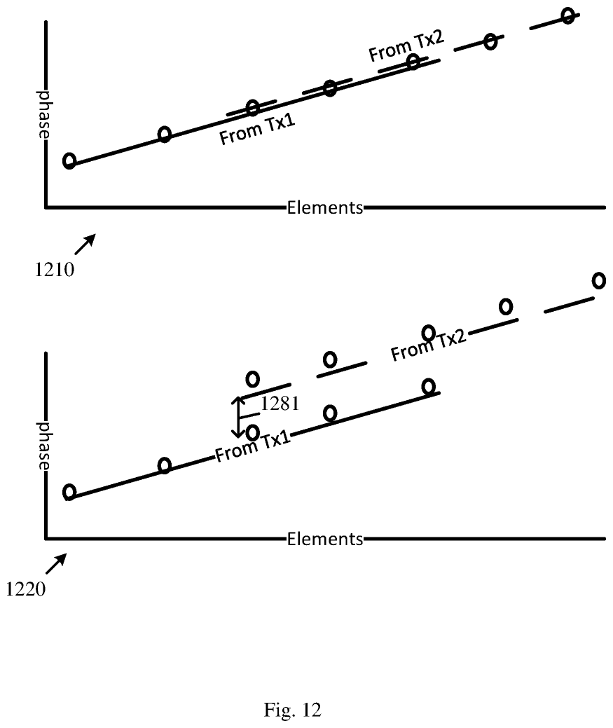

Reference is made to FIG. 12, which schematically illustrates graphs depicting phases of virtual antenna elements of a virtual antenna to illustrate one or more technical aspects, which may be addressed in accordance with some demonstrative aspects.

In one example, the graphs of FIG. 12 may depict phases of virtual antenna elements of the virtual antenna 1070 (FIG. 10).

For example, a first graph 1210 depicts phases of the virtual antenna elements of the virtual antenna 1070 (FIG. 10), for example, when signals communicated by the antenna array 1030 (FIG. 10) are not subject to a multipath effect.

For example, a second graph 1220 depicts phases of the virtual antenna elements of the virtual antenna 1070 (FIG. 10), for example, when signals communicated by the antenna array 1030 (FIG. 10) are subject to a multipath effect.

For example, as illustrated by graph 1220, there may be a phase shift 1281 between phases of the virtual antenna elements of the virtual antenna 1070 (FIG. 10) resulting from the first Tx antenna (1), and phases of the virtual antenna elements of the virtual antenna 1070 (FIG. 10) resulting from the second Tx antenna (2), for example, when signals communicated by the antenna array 1030 (FIG. 10) are subject to a multipath effect.

For example, as illustrated by graph 1210, there may be substantially no phase shift between phases of the virtual antenna elements of the virtual antenna 1070 (FIG. 10) resulting from the first Tx antenna (1), and the phases of the virtual antenna elements of the virtual antenna 1070 (FIG. 10) resulting from the second Tx antenna (2), for example, when signals communicated by the antenna array 1030 (FIG. 10) are not subject to a multipath effect.

For example, as illustrated by graph 1210, the phases of the virtual antenna elements of the virtual antenna 1070 (FIG. 10) resulting from the first Tx antenna (1), and the phases of the virtual antenna elements of the virtual antenna 1070 (FIG. 10) resulting from the second Tx antenna (2) may be substantially on a same line.

For example, the phase shift 1281 may distort an azimuth spectrum and/or an elevation spectrum of a MIMO radar implementing the antenna array 1030 (FIG. 10), for example, in the presence of a multipath effect.

In some demonstrative aspects, a radar device, e.g., as described above with reference to FIGS. 1-9, may be configured to implement one or more operations and/or functionalities of a multipath detection and mitigation mechanism, which may be configured to estimate a phase shift, e.g., phase shift 1281, for example, for a virtual array, e.g., as described below.

In some demonstrative aspects, the multipath detection and mitigation mechanism may be configured to compensate the estimated phase shift, for example, such that a multipath target may appear as a point target. For example, the multipath detection and mitigation mechanism may be configured to compensate the estimated phase shift, for example, such that the multipath target may not spread over different azimuth or elevation points, e.g., as described below.

In some demonstrative aspects, a phase shift estimation may be performed, for example, when a virtual array is generated with two or more subarrays, e.g., with overlapped virtual elements, for example, overlapped virtual elements 1072 (FIG. 10), e.g., as escribed below.

In some demonstrative aspects, the multipath detection and mitigation mechanism may be configured to provide a technical solution to support an increased dynamic range, for example, in an azimuth domain and/or in an elevation domain, e.g., for multipath cases.

In some demonstrative aspects, the multipath detection and mitigation mechanism may be configured to provide a technical solution to support improved resolution, for example, in the azimuth domain and/or in the elevation domain, e.g., for multipath cases.

In some demonstrative aspects, implementation of the multipath detection and mitigation mechanism may provide a technical solution to support performance, for example, in the presence of a multipath effect, which may be substantially similar to the performance without the presence of the multipath effect, e.g., as described below.

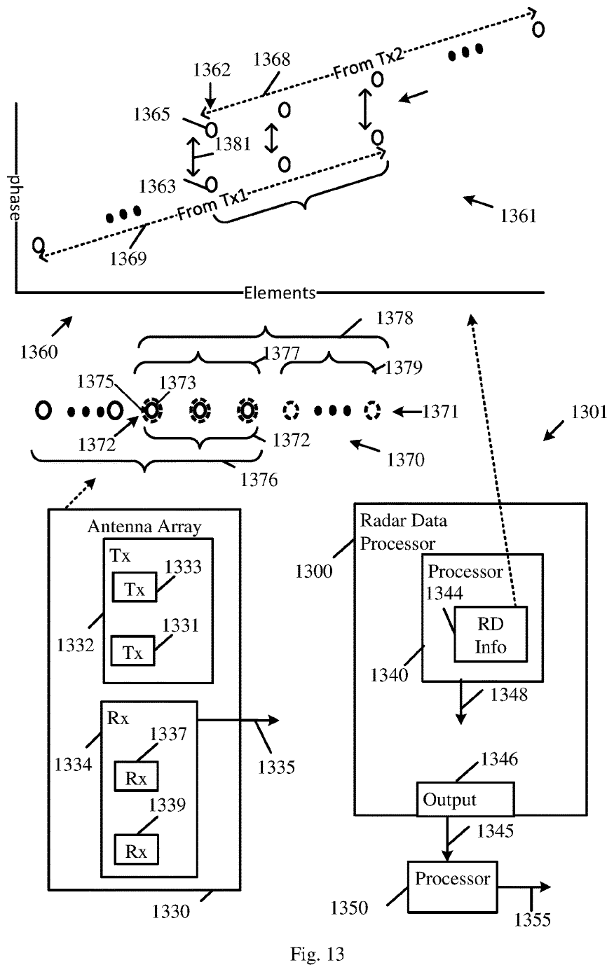

Reference is made to FIG. 13, which schematically illustrates a system 1301, in accordance with some demonstrative aspects.

In some demonstrative aspects, one or more elements of system 1301 may be configured to implement one or more operations and/or functionalities of a multipath detection and mitigation mechanism, e.g., as described below.

In some demonstrative aspects, system 1301 may be configured to provide a technical solution to mitigate a multipath effect, e.g., as described below.

In some demonstrative aspects, system 1301 may include a radar data processor 1300, e.g., as described below.

In some demonstrative aspects, radar data processor 1300 may be implemented, for example, as part of a radar device, e.g., a radar device 910 (FIG. 9).

In some demonstrative aspects, radar data processor 1300 may be implemented, for example, as part of a radar processor, e.g., radar processor 834 (FIG. 8), and/or BB processor 930 (FIG. 9).

For example, radar processor 834 (FIG. 8) may include one or more elements of radar data processor 1300, and/or may perform one or more operations and/or functionalities of radar data processor 1300.

In some demonstrative aspects, radar data processor 1300 may include a processor 1340, which may be configured to process RD information 1344 corresponding to an RD bin, e.g., as described below. For example, radar processor 834 (FIG. 8) may include one or more elements of processor 1340, and/or may perform one or more operations and/or functionalities of processor 1340; and/or BB processor 930 (FIG. 9) may include one or more elements of processor 1340, and/or may perform one or more operations and/or functionalities of processor 1340.

In some demonstrative aspects, processor 1340 may include, or may be implemented, partially or entirely, by circuitry and/or logic, e.g., one or more processors including circuitry and/or logic, memory circuitry and/or logic. Additionally or alternatively, one or more functionalities of processor 1340 may be implemented by logic, which may be executed by a machine and/or one or more processors, e.g., as described below.

In other aspects, radar data processor 1300 may be implemented as part of any other, dedicated, or indicated, element of a radar device, e.g., radar device 800 (FIG. 8) or radar device 910 (FIG. 9), and/or a radar system, e.g., radar system 901 (FIG. 9).

In some demonstrative aspects, the RD information 1344 corresponding to the RD bin may be based, for example, on radar Rx signals 1335 received by a plurality of Rx antennas 1334, for example, based on radar Tx signals from a plurality of Tx antennas 1332, e.g., as described below.

In some demonstrative aspects, as shown in FIG. 13, the a plurality of Tx antennas 1332 may include at least a first Tx antenna 1331 and a second Tx antenna 1333.

In some demonstrative aspects, as shown in FIG. 13, the a plurality of Tx antennas 1332 may include two Tx antennas. In other aspects, the a plurality of Tx antennas 1332 may include more than two Rx antennas 1334.

In some demonstrative aspects, the plurality of Tx antennas 1332 and the plurality of Rx antennas 1334 may be implemented and/or included as part of an antenna array 1330.

In some demonstrative aspects, antenna array 1330 may include a MIMO antenna array. For example, MIMO antenna array 881 (FIG. 8) may include one or more elements of antenna array 1330, and/or may perform one or more operations and/or functionalities of antenna array 1330.

In some demonstrative aspects, the RD information 1344 may include, or may be based on, for example, radar Rx data 811 (FIG. 8), e.g., which may be based on the Tx radar signals and the Rx signals communicated by the MIMO antenna array 881 (FIG. 8).

In some demonstrative aspects, processor 1340 may be configured to determine the RD information 1344, for example, based on the radar Rx signals 1335.

For example, processor 1340 may be configured to process radar Rx data, which may be based on radar Rx signals 1335, and to determine the RD information 1344, for example, based on the radar Rx data.

In other aspects, processor 1340 may receive the RD information 1344 from another processor, which may determine the RD information 1344, for example, based on the radar Rx signals 1335 and/or the radar Rx data, which may be based on signals 1335. For example, processor 1340 may be configured to identify the RD information 1344 in processed radar data, which may be provided, for example, by another processor of a radar device and/or system. In one example, the RD information 1344 may be generated and/or provided by processor 836 (FIG. 8), for example, based on the radar Rx data 811 (FIG. 1). In another example, the RD information 1344 may be generated and/or provided by BB processor 930 (FIG. 9), for example, based on radar signals communicated by the radar device 910 (FIG. 9).

In other aspects, the RD information 1344 may be generated and/or provided by any other element of a radar device and/or a radar system, e.g., radar device 800 (FIG. 8) and/or radar system 901 (FIG. 9).

In some demonstrative aspects, the RD information 1344 corresponding to the RD bin may include a plurality of virtual antenna values corresponding, for example, to a respective plurality of virtual antennas 1371 in a virtual antenna array 1370, e.g., as described below.

In some demonstrative aspects, virtual antenna array 1370 may be based, for example, on the plurality of Rx antennas 1334 and the plurality of Tx antennas 1332, e.g., as described below.

In some demonstrative aspects, processor 1340 may be configured to identify a multipath effect, for example, based RD information 1344, e.g., as descried below.

In some demonstrative aspects, processor 1340 may be configured to mitigate the detected multipath effect, e.g., as described below.

In some demonstrative aspects, as shown in FIG. 13, virtual antenna array 1370 may include an overlapped virtual antenna array, e.g., as described below.

In one example, antenna array 1330 may include antenna array 1030 (FIG. 10), and virtual antenna array 1370 may include virtual antenna array 1070 (FIG. 1), e.g., as described above. In other aspects, antenna array 1330 may include any other antenna array, e.g., including any suitable count of Tx antenna elements, any suitable count of Rx antenna elements, and/or any suitable arrangement of the Tx antenna elements and/or the Rx antenna elements; and virtual antenna array 1370 may include any other virtual antenna array based on the antenna array 1330.

In some demonstrative aspects, virtual antenna array 1370 may include a first plurality of virtual antenna elements 1376 (also referred to as “first-Tx virtual antennas”), which may be based, for example, on a plurality of combinations of a respective Rx antenna of the plurality of Rx antennas 1334 with the first Tx antenna 1331 of the plurality of Tx antennas 1332.

In some demonstrative aspects, virtual antenna array 1370 may include a second plurality of virtual antenna elements 1378 (also referred to as “second-Tx virtual antennas”), which may be based, for example, on a plurality of combinations of a respective Rx antenna of the plurality of Rx antennas 1334 with the second Tx antenna 1333 of the plurality of Tx antennas 1332.

In some demonstrative aspects, overlapped virtual antenna array 1370 may include one or more sets 1372 of overlapped virtual antennas (antenna elements), which may have substantially overlapping locations.

For example, as shown in FIG. 13, virtual antenna array 1370 may include three sets 1372 of overlapped virtual antennas. In other aspects, virtual antenna array 1370 may include any other count of one or more sets 1372 of overlapped virtual antennas.

In some demonstrative aspects, a set of overlapping virtual antennas 1372 may include a plurality of substantially overlapping virtual antennas, e.g., at substantially a same virtual location, e.g., as described below.

In some demonstrative aspects, a set of overlapping virtual antennas 1372 may include virtual antennas based on different Tx antennas 1332, e.g., as described below.

In some demonstrative aspects, a set of overlapping virtual antennas 1372 may include a virtual antenna from the first plurality of virtual antennas 1376, e.g., which are based on the first Tx antenna 1331, and a virtual antenna from the second plurality of virtual antennas 1378, e.g., which are based on the second Tx antenna 1333, e.g., as described below.

In some demonstrative aspects, the set of overlapping virtual antennas 1372 may include, for example, a first virtual antenna 1373, and a second virtual antenna 1375, e.g., as described below.

In some demonstrative aspects, the first virtual antenna 1373 may be based, for example, on a combination of the first Tx antenna 1331, e.g., of the plurality of Tx antennas 1332 of antenna array 1330, and a first Rx antenna 1337, e.g., of the plurality of Rx antennas 1334 of antenna array 1330, e.g., as described below.

In some demonstrative aspects, the second virtual antenna 1375 may be based, for example, on a combination of the second Tx antenna 1333, e.g., of the plurality of Tx antennas 1332 of antenna array 1330, and a second Rx antenna 1339, e.g., of the plurality of Rx antennas 1334 of antenna array 1330, e.g., as described below.

In some demonstrative aspects, processor 1340 may be configured to process the RD information 1344 corresponding to the RD bin, for example, to identify one or more sets of virtual antenna values corresponding to one or more sets of overlapping virtual antennas 1372, respectively, e.g., as described below.

In some demonstrative aspects, a set of virtual antenna values corresponding to the set of overlapping virtual antennas 1372 may include a first virtual antenna value corresponding to the first virtual antenna 1373, and a second virtual antenna value corresponding to the second virtual antenna 1375, respectively, e.g., as described below.

In some demonstrative aspects, processor 1340 may be configured to identify a multipath effect on the RD information 1344, for example, based on the one or more sets of virtual antenna values corresponding to the one or more sets of overlapping virtual antennas 1372, e.g., as described below.

In some demonstrative aspects, processor 1340 may be configured to determine a plurality of adjusted virtual antenna values, which may correspond, for example, to the plurality of second-Tx virtual antennas 1378, which are based on the second Tx antenna 1333, e.g., as described below.

In some demonstrative aspects, processor 1340 may be configured to determine the plurality of adjusted virtual antenna values, for example, by adjusting a plurality of second-Tx-based virtual antenna values, which may correspond, for example, to the plurality of second-Tx virtual antennas 1378, which are based on the second Tx antenna 1333, e.g., as described below.

In some demonstrative aspects, processor 1340 may be configured to determine the plurality of adjusted virtual antenna values, for example, by adjusting the plurality of second-Tx-based virtual antenna values, e.g., corresponding to the plurality of second-Tx virtual antennas 1378, for example, based on the one or more sets of virtual antenna values corresponding to the one or more sets of overlapping virtual antennas 1372, e.g., as described below.

In some demonstrative aspects, processor 1340 may be configured to adjust the plurality of second-Tx-based virtual antenna values, e.g., corresponding to the plurality of second-Tx virtual antennas 1378, for example, to mitigate a multipath effect on the RD information 1344, e.g., as described below.

In some demonstrative aspects, radar data processor 1340 may include an output 1346 to provide processed data 1345, for example, based on the plurality of adjusted virtual antenna values, e.g., as described below.

In some demonstrative aspects, output 1346 may include any suitable output interface, output unit, output module, output component, output circuitry, memory interface, memory access unit, memory writer, digital memory unit, bus interface, processor interface, or the like, which may be capable of outputting the processed data 1345 to a memory, a processor, and/or any other suitable component to handle the processed data 1345.

In some demonstrative aspects, system 1301 may include a processor 1350, which may be configured to generate radar information 1355, for example, based on the processed data 1345.

In one example, processor 1340 may provide the processed data 1345, for example, to the processor 1350, e.g., via output 1346. For example, radar processor 834 (FIG. 8) may include one or more elements of processor 1350, and/or may perform one or more operations and/or functionalities of processor 1350; and/or BB processor 930 (FIG. 9) may include one or more elements of processor 1350, and/or may perform one or more operations and/or functionalities of processor 1350.

In some demonstrative aspects, processor 1340 may provide the processed data 1345, for example, to any other component and/or element of a radar device, e.g., radar device 910 (FIG. 9) and/or radar device 800 (FIG. 8), and/or a radar system, e.g., radar system 901 (FIG. 9), for example, via output 1346.

In some demonstrative aspects, the plurality of second-Tx virtual antennas 1378 may include one or more overlapped second-Tx virtual antennas 1377, which are in the one or more sets of overlapping virtual antennas 1372, e.g., as described below.

For example, processor 1340 may be configured to determine the plurality of adjusted virtual antenna values to include one or more adjusted virtual antenna values corresponding to the one or more overlapped second-Tx virtual antennas 1377, e.g., as described below.

For example, processor 1340 may be configured to determine the one or more adjusted virtual antenna values corresponding to the one or more overlapped second-Tx virtual antennas 1377, for example, by adjusting one or more second-Tx-based virtual antenna values corresponding to the one or more overlapped second-Tx virtual antennas 1377, e.g., as described below.

For example, processor 1340 may be configured to adjust the one or more second-Tx-based virtual antenna values corresponding to the one or more overlapped second-Tx virtual antennas 1377, for example, based on the one or more sets of virtual antenna values corresponding to the one or more sets of overlapping virtual antennas 1372, e.g., as described below.

In some demonstrative aspects, the plurality of second-Tx virtual antennas 1378 may include one or more non-overlapped second-Tx virtual antennas 1379, which are not in the one or more sets of overlapping virtual antennas 1372, e.g., as described below.

For example, processor 1340 may be configured to determine the plurality of adjusted virtual antenna values to include one or more adjusted virtual antenna values corresponding to the one or more non-overlapped second-Tx virtual antennas 1379, e.g., as described below.

For example, processor 1340 may be configured to determine the one or more adjusted virtual antenna values corresponding to the non-overlapped second-Tx virtual antennas 1379, for example, by adjusting one or more second-Tx-based virtual antenna values corresponding to the one or more non-overlapped second-Tx virtual antennas 1379, e.g., as described below.

For example, processor 1340 may be configured to adjust the one or more second-Tx-based virtual antenna values corresponding to non-overlapped second-Tx virtual antennas 1379, for example, based on the one or more sets of virtual antenna values corresponding to the one or more sets of overlapping virtual antennas 1372, e.g., as described below.

In some demonstrative aspects, processor 1340 may be configured to determine the plurality of adjusted virtual antenna values 1348, for example, for substantially all second-Tx-based virtual antenna values corresponding to substantially all second-Tx virtual antennas 1378, which are based on the second Tx antenna 1333, e.g., as described below.

For example, processor 1340 may be configured to determine the plurality of adjusted virtual antenna values 1348, for example, for substantially all of the one or more overlapped second-Tx virtual antennas 1377, and substantially all of the one or more non-overlapped second-Tx virtual antennas 1379 corresponding to the second Tx antenna 1333.

In some demonstrative aspects, processor 1340 may be configured to determine the plurality of adjusted virtual antenna values 1348, for example, by adjusting phases of the plurality of second-Tx-based virtual antenna values, for example, based on the one or more sets of virtual antenna values corresponding to the one or more sets of overlapping virtual antennas 1372, e.g., as described below.

In some demonstrative aspects, as shown in FIG. 13, a graph 1361 may represent phases of the plurality of virtual antenna values corresponding to the plurality of virtual antennas, e.g., as described below.

For example, as shown in FIG. 13, graph 1361 may include phases 1369 of the plurality of virtual antenna values corresponding to the first plurality of virtual antennas 1376.

For example, as shown in FIG. 13, graph 1361 may include phases 1368 of the plurality of virtual antenna values corresponding to the second plurality of virtual antennas 1378.

In some demonstrative aspects, processor 1340 may be configured to determine a phase shift corresponding to the second Tx antenna 1333, for example, based on the one or more sets of virtual antenna values corresponding to the one or more sets of overlapping virtual antennas 1372, e.g., as described below.

In some demonstrative aspects, processor 1340 may be configured to determine the plurality of adjusted virtual antenna values 1348, for example, by adjusting the phases 1368 of the plurality of second-Tx-based phase values corresponding to the virtual antennas 1378, for example, based on the phase shift corresponding to the second Tx antenna 1333, e.g., as described below.

In some demonstrative aspects, processor 1340 may be configured to determine the phase shift corresponding to the second Tx antenna 1333, for example, to represent a multipath effect, for example, on the RD information 1344, e.g., as described below.

In some demonstrative aspects, processor 1340 may be configured to determine the phase shift corresponding to the second Tx antenna 1333, for example, to include a relative phase shift between the plurality of second-Tx virtual antennas 1378 and the plurality of first-Tx virtual antennas 1376, which are based on the first Tx antenna 1331, e.g., as described below.

In some demonstrative aspects, processor 1340 may be configured to determine an adjusted phase value corresponding to the second virtual antenna 1375, for example, by subtracting the phase shift from a phase 1365 of the second virtual antenna value corresponding to the second virtual antenna 1375, e.g., as described below.

In some demonstrative aspects, processor 1340 may be configured to determine the phase shift corresponding to the second Tx antenna 1333, for example, based on one or more phase differences 1381 corresponding to the one or more sets of virtual antenna values, which correspond to the one or more sets of overlapping virtual antennas 1372, e.g., as described below.

In some demonstrative aspects, a phase difference 1381 corresponding to a set 1362 of virtual antenna values, which correspond to a set of overlapping virtual antennas 1372, may be based, for example, on a difference between the phase 1365 of the second virtual antenna value corresponding to the second virtual antenna 1375, and a phase 1363 of the first virtual antenna value corresponding to the first virtual antenna 1373, e.g., as described below.

In some demonstrative aspects, processor 1340 may be configured to determine the phase shift, for example, based on a criterion to minimize the one or more phase differences 1381 corresponding to the one or more sets of virtual antenna values, which correspond to the one or more sets of overlapping virtual antennas 1372, e.g., as described below.

In some demonstrative aspects, the one or more sets of virtual antenna values corresponding to the one or more sets of overlapping virtual antennas 1372 may include a plurality of sets of virtual antenna values corresponding to a plurality of sets of overlapping virtual antennas 1372. For example, the one or more phase differences 1381 may include a plurality of phase differences 1381 corresponding to the plurality of sets of virtual antenna values corresponding to the plurality of sets of overlapping virtual antennas 1372.

In some demonstrative aspects, processor 1340 may be configured to determine the phase shift corresponding to the second Tx antenna 1333, for example, based on a statistical function applied to the plurality of phase differences 1381 corresponding to the plurality of sets of virtual antenna values corresponding to the plurality of sets of overlapping virtual antennas 1372, e.g., as described below.

In some demonstrative aspects, processor 1340 may be configured to determine the phase shift corresponding to the second Tx antenna 1333, for example, based on an average of the plurality of phase differences 1381 corresponding to the plurality of sets of virtual antenna values corresponding to the plurality of sets of overlapping virtual antennas 1372, e.g., as described below.

In some demonstrative aspects, processor 1340 may be configured to determine the phase difference 1381 corresponding to the set of virtual antenna values, which corresponds to set of overlapping virtual antennas 1372, for example, based on a product of a conjugate of the first virtual antenna value corresponding to the first virtual antenna 1373 and the second virtual antenna value corresponding to the second virtual antenna 1375, e.g., as described below.

In some demonstrative aspects, processor 1340 may be configured to determine more than one phase shift, for example, corresponding to more than one RD bin, e.g., as described below.

In some demonstrative aspects, processor 1340 may be configured to determine a plurality of phase shifts, for example, corresponding to a plurality of RD bins, for example, based on RD information 1344 corresponding to the plurality of RD bins, e.g., as described below.

In some demonstrative aspects, processor 1340 may be configured to determine a first phase shift corresponding to a first RD bin, for example, based on one or more first sets of virtual antenna values corresponding to the first RD bin, e.g., as described below.

In some demonstrative aspects, processor 1340 may be configured to determine a first plurality of adjusted virtual antenna values for the first RD bin, for example, based on the first phase shift, e.g., as described below.

In some demonstrative aspects, processor 1340 may be configured to determine a second phase shift corresponding to a second RD bin, for example, based on one or more second sets of virtual antenna values corresponding to the second RD bin, e.g., as described below.

In some demonstrative aspects, the second phase shift may be different from the first phase shift.

In some demonstrative aspects, processor 1340 may be configured to determine a second plurality of adjusted virtual antenna values for the second RD bin, for example, based on the second phase shift, e.g., as described below.

In some demonstrative aspects, processor 1340 may be configured to generate the processed data 1345 based, for example, on the first plurality of adjusted virtual antenna values and/or the second plurality of adjusted virtual antenna values, e.g., as described below.

In some demonstrative aspects, the plurality of Tx antennas 1332 may include more than two Tx antennas, e.g., as described below.

In some demonstrative aspects, the plurality of Tx antennas 1332 may include a third Tx antenna (not shown in FIG. 13). In other aspects, the plurality of Tx antennas 1332 may include more than three Tx antennas.

In some demonstrative aspects, the set of virtual antenna values corresponding to the set of overlapping virtual antennas 1372 may include a third virtual antenna value (not shown in FIG. 13) corresponding to a third virtual antenna (not shown in FIG. 13), e.g., as described below.

In some demonstrative aspects, the third virtual antenna may be based, for example, on a combination of the third Tx antenna and a third Rx antenna (not shown in FIG. 13) of the plurality of Rx antennas 1334.

In some demonstrative aspects, processor 1340 may be configured to determine another plurality of adjusted virtual antenna values, for example, by adjusting a plurality of third-Tx-based virtual antenna values based on the one or more sets of virtual antenna values corresponding to the one or more sets of overlapping virtual antennas 1372, e.g., as described below.

In some demonstrative aspects, the plurality of third-Tx-based virtual antenna values may correspond to a plurality of third-Tx virtual antennas (not shown in FIG. 13), which are based on the third Tx antenna, e.g., as described below.

In some demonstrative aspects, processor 1340 may be configured to use the sets of virtual antenna values corresponding to the one or more sets of overlapping virtual antennas (elements) 1372, for example, to measure a phase shift, e.g., a multipath phase jump, for example, for a range domain, a Doppler domain, an azimuth domain, and/or an elevation domain, e.g., for any range, Doppler, azimuth, and/or elevation domain.

In some demonstrative aspects, processor 1340 may be configured to determine a phase change, denoted xₜₓ, over different Tx antennas, and/or a phase shift, denoted xᵣₓ, over different Rx antennas, e.g., as follows:

$${x}_{t x} = e \frac{1 j 2 π sin ( {θ}_{tx} ) {d}_{t x} [ 0 : {N}_{tx} - 1 ]}{λ} , {x}_{r x} = e \frac{1 j 2 π sin ( {θ}_{r x} ) {d}_{r x} [ 0 : {N}_{r x} - 1 ]}{λ}$$

In some demonstrative aspects, for example, a Uniform Linear Array (ULA) with OL overlapped virtual antennas may be assumed, for example, based on the antenna array 1330 including two transmit antennas, e.g., with a spacing, denoted dₜₓ, between the two transmit antennas, and N Rx antennas, e.g., with a spacing, denoted dᵣₓ, for example, of λ/2, wherein λ denotes a wavelength of radar signals communicated by the array, for example, as follows:

$${d}_{t x} = \frac{( N - OL ) λ}{2} , {d}_{rx} = \frac{λ}{2}$$

In other aspects, any other suitable count of Tx antennas, any suitable count of Rx antennas, any other suitable spacing between Tx antennas, and/or any other suitable spacing between Rx antennas may be implemented.

In some demonstrative aspects, an n-th set of virtual antenna values corresponding to a n-th set of overlapping virtual antennas 1372, e.g., for n=0, . . . , OL−1, may include, for example, a first virtual antenna value (sample), denoted x_{virt overlap1}(n), corresponding to a first virtual antenna in the n-th set of overlapping virtual antennas 1372, which may be based on a first Tx antenna; and a second virtual antenna value (sample), denoted x_{virt overlap2}(n), corresponding to a second virtual antenna in the n-th set of overlapping virtual antennas 1372, which may be based on a second Tx antenna.

For example, the first virtual antenna value (sample) x_{virt overlap1}(1) may correspond to the virtual antenna 1373, which may be based on the Tx antenna 1331.

For example, the second virtual antenna value (sample) x_{virt overlap2}(1) may correspond to the virtual antenna 1375, which may be based on the Tx antenna 1333.

In some demonstrative aspects, the first virtual antenna value (sample) x_{virt overlap1}(n) may be modeled, for example, as x_{virt overlap1}(n)=xₜₓ(1)xᵣₓ(Nᵣₓ−n), and/or the second virtual antenna value (sample) x_{virt overlap2}(n) may be modeled, for example, as x_{virt overlap2}(n)=xₜₓ(2)xᵣₓ(n).

In some demonstrative aspects, it may be noted that x_{virt overlap1}(n)=x_{virt overlap2}(n), for example, when θₜₓ=θᵣₓ, for example, when there is substantially no multipath effect.

In some demonstrative aspects, for example, when θₜₓ≠θᵣₓ, e.g., in the presence of a multipath effect, there may be a phase shift (“phase jump”), denoted φ, for example, between these points, e.g., x_{virt overlap1}(n)=e^{1jφ}x_{virt overlap2}(n).

In some demonstrative aspects, for example, the case of θₜₓ≠θᵣₓ may be the result of result from the multipath effect, e.g., where a transmit direction may be different from a receive direction.

In some demonstrative aspects, the virtual array 1370 may be distorted, e.g., as depicted by graph 1361, for example, if the phase shift φ is not be adjusted.

In some demonstrative aspects, the distortion of the virtual array may result in a degraded azimuth and/or elevation separation, and/or a degraded dynamic range.

In some demonstrative aspects, processor 1340 may be configured to estimated phase shift, denoted \hat{φ}, to estimate the phase shift φ, e.g., as follows:

$$\hat{ϕ} = ∠ ( \frac{1}{OL} {\sum }_{n = 0}^{OL - 1} conj ( {x}_{virt -} {overlap}_{1} ( n ) ) * {x}_{virt -} {overlap}_{2} ( n ) )$$

In some demonstrative aspects, processor 1340 may be configured to compensate the phase shift φ, e.g., after estimating the phase shift φ, for example, by compensating xₜₓ(2)xᵣₓ(n), e.g., by e^{-1j\hat{φ}}.

In some demonstrative aspects, the phase jump φ may be unique per θₜₓ, θᵣₓ pair, and may be estimated on a per target RD bin, e.g., as described above.

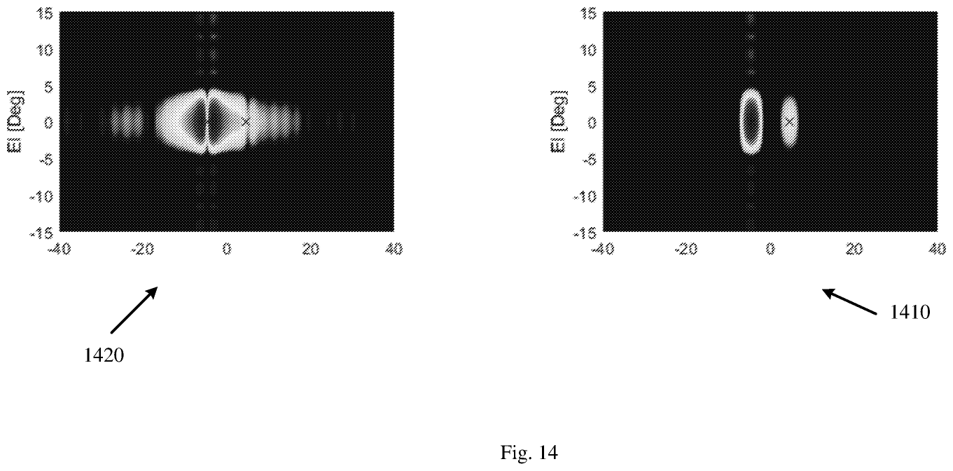

Reference is made to FIG. 14, which schematically illustrates simulation results of an azimuth performance and an elevation performance, in accordance with some demonstrative aspects.

For example, as shown in FIG. 14, a first azimuth/elevation map 1410 represents simulation results when implementing a phase shift compensation mechanism, e.g., as described above.

For example, as shown in FIG. 14, a second azimuth/elevation map 1420 represents simulation results when the phase shift compensation mechanism is not implemented.

For example, as shown in FIG. 14, azimuth/elevation map 1410 may provide better performance, for example, in a detection scenario of two targets at different azimuths, and with different Radar Cross Section (RCS), for example, compared to azimuth/elevation map 1420.

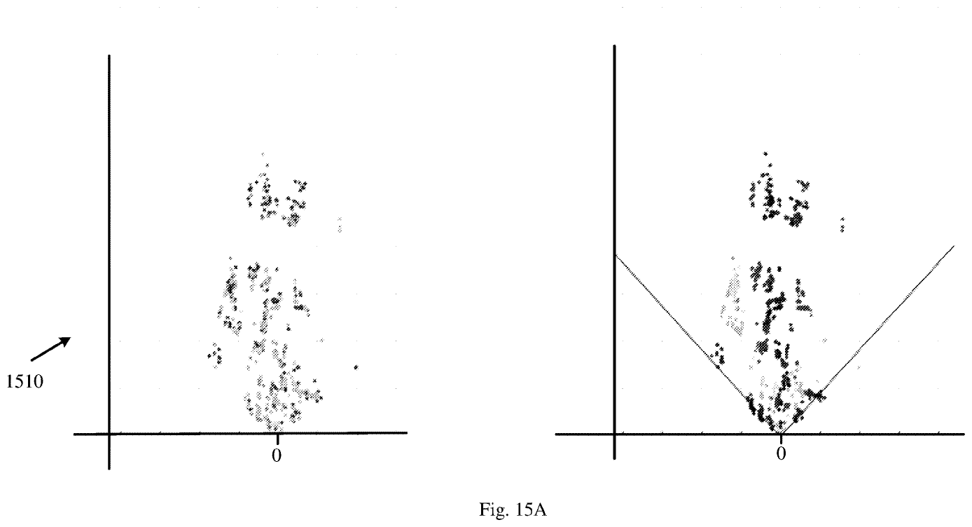

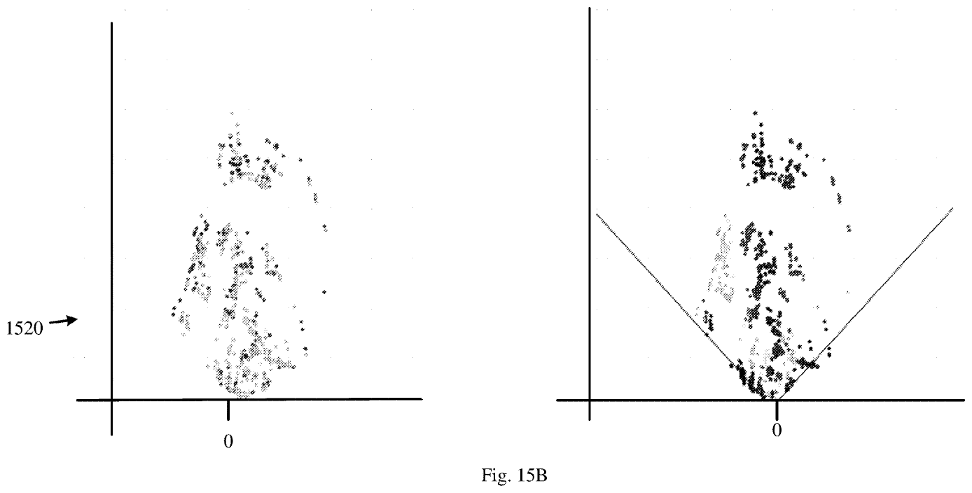

Reference is made to FIG. 15A and FIG. 15B, which schematically illustrate graphs depicting simulation results of a point cloud with a multipath phase correction and without the multipath phase correction, respectively, in accordance with some demonstrative aspects.

In some demonstrative aspects, as shown in FIG. 15A, graphs 1510 depict simulation results with implementation of a multipath phase correction mechanism, e.g., as described above.

In some demonstrative aspects, as shown in FIG. 15B, graphs 1520 depict simulation results without implementing the multipath phase correction mechanism.

For example, as shown in FIGS. 15A and 15B, simulating a complete frame with a MIMO radar in a ray tracing simulator may result in an improved point cloud (graphs 1510), when the phase shift correction mechanism is implemented, for example, compared to a point cloud (graphs 1520), when the phase shift correction mechanism is not implemented.

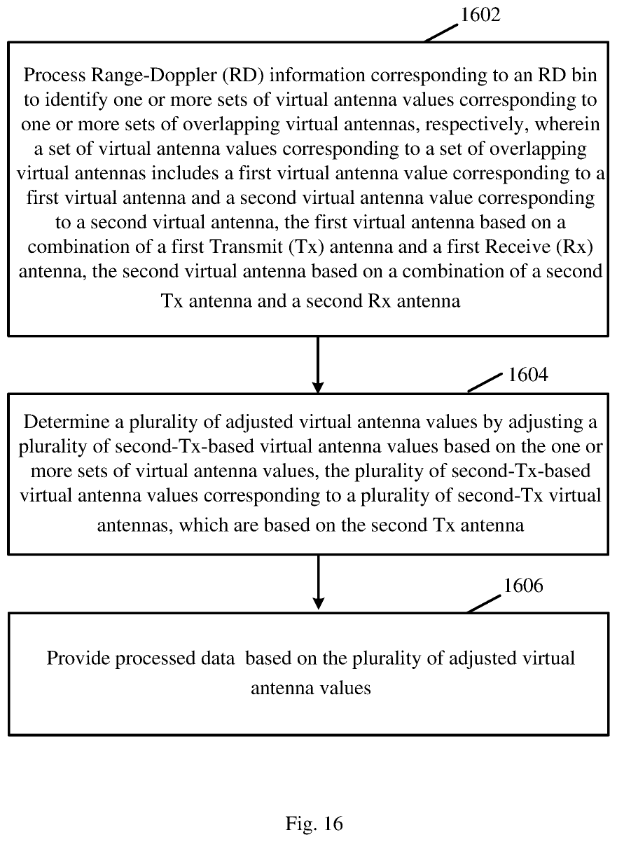

Reference is made to FIG. 16, which schematically illustrates a method of processing RD information, in accordance with some demonstrative aspects. For example, one or more of the operations of the method of FIG. 16 may be performed by a system, e.g., radar system 900 (FIG. 9), and/or system 1301 (FIG. 13), a radar device, e.g., radar device 101 (FIG. 1), radar device 800 (FIG. 8), and/or radar device 910 (FIG. 9); a processor, e.g., radar data processor 1300 (FIG. 13), processor 1340 (FIG. 13), processor 1040 (FIG. 10), radar processor 834 (FIG. 8), and/or baseband processor 930 (FIG. 9).

As indicated at block 1602, the method may include processing RD information corresponding to an RD bin to identify one or more sets of virtual antenna values corresponding to one or more sets of overlapping virtual antennas, respectively. For example, a set of virtual antenna values corresponding to a set of overlapping virtual antennas may include a first virtual antenna value corresponding to a first virtual antenna, and a second virtual antenna value corresponding to a second virtual antenna. For example, the first virtual antenna may be based on a combination of a first Tx antenna and a first Rx antenna, and the second virtual antenna may be based on a combination of a second Tx antenna and a second Rx antenna. For example, processor 1340 (FIG. 13) may process the RD information 1344 (FIG. 13) corresponding to the RD bin, for example, to identify the one or more sets of virtual antenna values corresponding to the one or more sets of overlapping virtual antennas 1372 (FIG. 13), respectively, e.g., as described above.

As indicated at block 1604, the method may include determining a plurality of adjusted virtual antenna values, for example, by adjusting a plurality of second-Tx-based virtual antenna values based on the one or more sets of virtual antenna values. For example, the plurality of second-Tx-based virtual antenna values may correspond to a plurality of second-Tx virtual antennas, which are based on the second Tx antenna. For example, processor 1340 (FIG. 13) may determine the plurality of adjusted virtual antenna values 1348 (FIG. 13), for example, by adjusting the plurality of second-Tx-based virtual antenna values corresponding to the plurality of second-Tx virtual antennas 1378 (FIG. 13), for example, based on the one or more sets of virtual antenna values corresponding to the one or more sets of overlapping virtual antennas 1372 (FIG. 13), e.g., as described above.

As indicated at block 1606, the method may include providing processed data based on the plurality of adjusted virtual antenna values. For example, processor 1340 (FIG. 13) may be configured to cause output 1346 (FIG. 13) to provide the processed data 1345 (FIG. 13), for example, based on the plurality of adjusted virtual antenna values 1348 (FIG. 13), e.g., as described above.

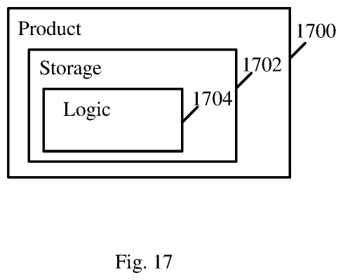

Reference is made to FIG. 17, which schematically illustrates a product of manufacture 1700, in accordance with some demonstrative aspects. Product 1700 may include one or more tangible computer-readable (“machine-readable”) non-transitory storage media 1702, which may include computer-executable instructions, e.g., implemented by logic 1704, operable to, when executed by at least one computer processor, enable the at least one computer processor to implement one or more operations and/or functionalities described with reference to any of the FIGS. 1-16, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1700 and/or machine-readable storage media 1702 may include one or more types of computer-readable storage media capable of storing data, including volatile memory, non-volatile memory, removable or non-removable memory, erasable or non-erasable memory, writeable or re-writeable memory, and the like. For example, machine-readable storage media 1702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising a processor configured to process Range-Doppler (RD) information corresponding to an RD bin to identify one or more sets of virtual antenna values corresponding to one or more sets of overlapping virtual antennas, respectively, wherein a set of virtual antenna values corresponding to a set of overlapping virtual antennas comprises a first virtual antenna value corresponding to a first virtual antenna and a second virtual antenna value corresponding to a second virtual antenna, the first virtual antenna based on a combination of a first Transmit (Tx) antenna and a first Receive (Rx) antenna, the second virtual antenna based on a combination of a second Tx antenna and a second Rx antenna; and determine a plurality of adjusted virtual antenna values by adjusting a plurality of second-Tx-based virtual antenna values based on the one or more sets of virtual antenna values, the plurality of second-Tx-based virtual antenna values corresponding to a plurality of second-Tx virtual antennas, which are based on the second Tx antenna; and an output to provide processed data based on the plurality of adjusted virtual antenna values.

Example 2 includes the subject matter of Example 1, and optionally, wherein the processor is configured to determine the plurality of adjusted virtual antenna values by adjusting phases of the plurality of second-Tx-based virtual antenna values based on the one or more sets of virtual antenna values.

Example 3 includes the subject matter of Example 1 or 2, and optionally, wherein the processor is configured to determine a phase shift corresponding to the second Tx antenna based on the one or more sets of virtual antenna values, and to determine the plurality of adjusted virtual antenna values by adjusting phases of the plurality of second-Tx-based phase values based on the phase shift corresponding to the second Tx antenna.

Example 4 includes the subject matter of Example 3, and optionally, wherein the processor is configured to determine the phase shift corresponding to the second Tx antenna based on one or more phase differences corresponding to the one or more sets of virtual antenna values, wherein a phase difference corresponding to the set of virtual antenna values is based on a difference between a phase of the second virtual antenna value and a phase of the first virtual antenna value.

Example 5 includes the subject matter of Example 4, and optionally, wherein the processor is configured to determine the phase shift corresponding to the second Tx antenna based on a statistical function applied to a plurality of phase differences corresponding to a plurality of sets of virtual antenna values, the plurality of sets of virtual antenna values corresponding to a respective plurality of sets of overlapping virtual antennas.

Example 6 includes the subject matter of Example 4 or 5, and optionally, wherein the processor is configured to determine the phase shift corresponding to the second Tx antenna based on an average of a plurality of phase differences corresponding to a plurality of sets of virtual antenna values, the plurality of sets of virtual antenna values corresponding to a respective plurality of sets of overlapping virtual antennas.

Example 7 includes the subject matter of any one of Examples 4-6, and optionally, wherein the processor is configured to determine the phase difference corresponding to the set of virtual antenna values based on a product of a conjugate of the first virtual antenna value and the second virtual antenna value.

Example 8 includes the subject matter of any one of Examples 4-7, and optionally, wherein the processor is configured to determine the phase shift based on a criterion to minimize the one or more phase differences corresponding to the one or more sets of virtual antenna values.

Example 9 includes the subject matter of any one of Examples 3-8, and optionally, wherein the processor is configured to determine an adjusted phase value corresponding to the second virtual antenna by subtracting the phase shift from a phase of the second virtual antenna value.

Example 10 includes the subject matter of any one of Examples 3-9, and optionally, wherein the processor is configured to determine a first phase shift corresponding to a first RD bin based on one or more first sets of virtual antenna values corresponding to the first RD bin; determine a first plurality of adjusted virtual antenna values for the first RD bin based on the first phase shift; determine a second phase shift corresponding to a second RD bin based on one or more second sets of virtual antenna values corresponding to the second RD bin, wherein the second phase shift is different from the first phase shift; determine a second plurality of adjusted virtual antenna values for the second RD bin based on the second phase shift; and generate the processed data based on the first plurality of adjusted virtual antenna values and the second plurality of adjusted virtual antenna values.

Example 11 includes the subject matter of any one of Examples 3-10, and optionally, wherein the processor is configured to determine the phase shift comprising a relative phase shift between the plurality of second-Tx virtual antennas and a plurality of first-Tx virtual antennas, which are based on the first Tx antenna.

Example 12 includes the subject matter of any one of Examples 3-11, and optionally, wherein the processor is configured to determine the phase shift to represent a multipath effect on the RD information.

Example 13 includes the subject matter of any one of Examples 1-12, and optionally, wherein the plurality of second-Tx virtual antennas comprises one or more overlapped second-Tx virtual antennas, which are in the one or more sets of overlapping virtual antennas.

Example 14 includes the subject matter of any one of Examples 1-13, and optionally, wherein the plurality of second-Tx virtual antennas comprises one or more non-overlapped second-Tx virtual antennas, which are not in the one or more sets of overlapping virtual antennas.

Example 15 includes the subject matter of any one of Examples 1-14, and optionally, wherein the processor is configured to determine the plurality of adjusted virtual antenna values for substantially all second-Tx-based virtual antenna values corresponding to substantially all second-Tx virtual antennas, which are based on the second Tx antenna.

Example 16 includes the subject matter of any one of Examples 1-15, and optionally, wherein the set of virtual antenna values corresponding to the set of overlapping virtual antennas comprises a third virtual antenna value corresponding to a third virtual antenna, the third virtual antenna based on a combination of a third Tx antenna and a third Rx antenna.

Example 17 includes the subject matter of Example 16, and optionally, wherein the processor is configured to determine another plurality of adjusted virtual antenna values by adjusting a plurality of third-Tx-based virtual antenna values based on the one or more sets of virtual antenna values, the plurality of third-Tx-based virtual antenna values corresponding to a plurality of third-Tx virtual antennas, which are based on the third Tx antenna.

Example 18 includes the subject matter of any one of Examples 1-17, and optionally, wherein the processor is configured to identify a multipath effect on the RD information based on the one or more sets of virtual antenna values.

Example 19 includes the subject matter of any one of Examples 1-18, and optionally, wherein the processor is configured to adjust the plurality of second-Tx-based virtual antenna values to mitigate a multipath effect on the RD information.

Example 20 includes the subject matter of any one of Examples 1-19, and optionally, wherein the RD information corresponding to the RD bin is based on radar Rx signals received by a plurality of Rx antennas based on radar Tx signals from a plurality of Tx antennas, wherein the RD information comprises a plurality of virtual antenna values corresponding to a respective plurality of virtual antennas in a virtual antenna array based on the plurality of Rx antennas and the plurality of Tx antennas.

Example 21 includes the subject matter of Example 20, and optionally, comprising the plurality of Rx antennas and the plurality of Tx antennas.

Example 22 includes the subject matter of any one of Examples 1-21, and optionally, comprising a radar processor configured to generate radar information based on the processed data.

Example 23 includes the subject matter of Example 22, and optionally, comprising a vehicle, the vehicle comprising a system controller to control one or more systems of the vehicle based on the radar information.

Example 24 includes a radar system comprising the subject matter of any of Examples 1-23.

Example 25 includes a vehicle comprising the subject matter of any of Examples 1-23.

Example 26 includes an apparatus comprising means for performing any of the described operations of any of Examples 1-23.

Example 27 includes a machine-readable medium that stores instructions for execution by a processor to perform any of the described operations of any of Examples 1-23.

Example 28 comprises a product comprising one or more tangible computer-readable non-transitory storage media comprising instructions operable to, when executed by at least one processor, enable the at least one processor to cause a device and/or system to perform any of the described operations of any of Examples 1-23.

Example 29 includes an apparatus comprising a memory; and processing circuitry configured to perform any of the described operations of any of Examples 1-23.

Example 30 includes a method including any of the described operations of any of Examples 1-23.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-26. (canceled)

27. An apparatus comprising:
a processor configured to:
process Range-Doppler (RD) information corresponding to an RD bin to identify one or more sets of virtual antenna values corresponding to one or more sets of overlapping virtual antennas, respectively, wherein a set of virtual antenna values corresponding to a set of overlapping virtual antennas comprises a first virtual antenna value corresponding to a first virtual antenna and a second virtual antenna value corresponding to a second virtual antenna, the first virtual antenna based on a combination of a first Transmit (Tx) antenna and a first Receive (Rx) antenna, the second virtual antenna based on a combination of a second Tx antenna and a second Rx antenna; and
determine a plurality of adjusted virtual antenna values by adjusting a plurality of second-Tx-based virtual antenna values based on the one or more sets of virtual antenna values, the plurality of second-Tx-based virtual antenna values corresponding to a plurality of second-Tx virtual antennas, which are based on the second Tx antenna; and
an output to provide processed data based on the plurality of adjusted virtual antenna values.

28. The apparatus of claim 27, wherein the processor is configured to determine the plurality of adjusted virtual antenna values by adjusting phases of the plurality of second-Tx-based virtual antenna values based on the one or more sets of virtual antenna values.

29. The apparatus of claim 27, wherein the processor is configured to determine a phase shift corresponding to the second Tx antenna based on the one or more sets of virtual antenna values, and to determine the plurality of adjusted virtual antenna values by adjusting phases of the plurality of second-Tx-based phase values based on the phase shift corresponding to the second Tx antenna.

30. The apparatus of claim 29, wherein the processor is configured to determine the phase shift corresponding to the second Tx antenna based on one or more phase differences corresponding to the one or more sets of virtual antenna values, wherein a phase difference corresponding to the set of virtual antenna values is based on a difference between a phase of the second virtual antenna value and a phase of the first virtual antenna value.

31. The apparatus of claim 30, wherein the processor is configured to determine the phase difference corresponding to the set of virtual antenna values based on a product of a conjugate of the first virtual antenna value and the second virtual antenna value.

32. The apparatus of claim 30, wherein the processor is configured to determine the phase shift corresponding to the second Tx antenna based on a criterion to minimize the one or more phase differences corresponding to the one or more sets of virtual antenna values.

33. The apparatus of claim 29, wherein the processor is configured to determine the phase shift corresponding to the second Tx antenna based on a statistical function applied to a plurality of phase differences corresponding to a plurality of sets of virtual antenna values, the plurality of sets of virtual antenna values corresponding to a respective plurality of sets of overlapping virtual antennas.

34. The apparatus of claim 29, wherein the processor is configured to determine the phase shift corresponding to the second Tx antenna based on an average of a plurality of phase differences corresponding to a plurality of sets of virtual antenna values, the plurality of sets of virtual antenna values corresponding to a respective plurality of sets of overlapping virtual antennas.

35. The apparatus of claim 29, wherein the processor is configured to determine an adjusted phase value corresponding to the second virtual antenna by subtracting the phase shift from a phase of the second virtual antenna value.

36. The apparatus of claim 29, wherein the processor is configured to determine the phase shift comprising a relative phase shift between the plurality of second-Tx virtual antennas and a plurality of first-Tx virtual antennas, which are based on the first Tx antenna.

37. The apparatus of claim 29, wherein the processor is configured to determine the phase shift to represent a multipath effect on the RD information.

38. The apparatus of claim 27, wherein the processor is configured to:
determine a first phase shift corresponding to a first RD bin based on one or more first sets of virtual antenna values corresponding to the first RD bin;
determine a first plurality of adjusted virtual antenna values for the first RD bin based on the first phase shift;
determine a second phase shift corresponding to a second RD bin based on one or more second sets of virtual antenna values corresponding to the second RD bin, wherein the second phase shift is different from the first phase shift;
determine a second plurality of adjusted virtual antenna values for the second RD bin based on the second phase shift; and
generate the processed data based on the first plurality of adjusted virtual antenna values and the second plurality of adjusted virtual antenna values.

39. The apparatus of claim 27, wherein the plurality of second-Tx virtual antennas comprises one or more overlapped second-Tx virtual antennas, which are in the one or more sets of overlapping virtual antennas.

40. The apparatus of claim 27, wherein the plurality of second-Tx virtual antennas comprises one or more non-overlapped second-Tx virtual antennas, which are not in the one or more sets of overlapping virtual antennas.

41. The apparatus of claim 27, wherein the processor is configured to determine the plurality of adjusted virtual antenna values for substantially all second-Tx-based virtual antenna values corresponding to substantially all second-Tx virtual antennas, which are based on the second Tx antenna.

42. The apparatus of claim 27, wherein the set of virtual antenna values corresponding to the set of overlapping virtual antennas comprises a third virtual antenna value corresponding to a third virtual antenna, the third virtual antenna based on a combination of a third Tx antenna and a third Rx antenna.

43. The apparatus of claim 42, wherein the processor is configured to determine another plurality of adjusted virtual antenna values by adjusting a plurality of third-Tx-based virtual antenna values based on the one or more sets of virtual antenna values, the plurality of third-Tx-based virtual antenna values corresponding to a plurality of third-Tx virtual antennas, which are based on the third Tx antenna.

44. The apparatus of claim 27, wherein the processor is configured to adjust the plurality of second-Tx-based virtual antenna values to mitigate a multipath effect on the RD information.

45. The apparatus of claim 27, wherein the RD information corresponding to the RD bin is based on radar Rx signals received by a plurality of Rx antennas based on radar Tx signals from a plurality of Tx antennas, wherein the RD information comprises a plurality of virtual antenna values corresponding to a respective plurality of virtual antennas in a virtual antenna array based on the plurality of Rx antennas and the plurality of Tx antennas.

46. The apparatus of claim 27 comprising a radar device, the radar device comprising a plurality of Transmit (Tx) antennas to transmit radar Tx signals, a plurality of Receive (Rx) antennas to receive radar Rx signals based on the radar Tx signals, and the processor, wherein the RD information is based on the radar Rx signals.

47. A product comprising one or more tangible computer-readable non-transitory storage media comprising instructions operable to, when executed by at least one processor, enable the at least one processor to:
process Range-Doppler (RD) information corresponding to an RD bin to identify one or more sets of virtual antenna values corresponding to one or more sets of overlapping virtual antennas, respectively, wherein a set of virtual antenna values corresponding to a set of overlapping virtual antennas comprises a first virtual antenna value corresponding to a first virtual antenna and a second virtual antenna value corresponding to a second virtual antenna, the first virtual antenna based on a combination of a first Transmit (Tx) antenna and a first Receive (Rx) antenna, the second virtual antenna based on a combination of a second Tx antenna and a second Rx antenna;
determine a plurality of adjusted virtual antenna values by adjusting a plurality of second-Tx-based virtual antenna values based on the one or more sets of virtual antenna values, the plurality of second-Tx-based virtual antenna values corresponding to a plurality of second-Tx virtual antennas, which are based on the second Tx antenna; and
output processed data based on the plurality of adjusted virtual antenna values.

48. The product of claim 47, wherein the instructions, when executed, cause the at least one processor to determine the plurality of adjusted virtual antenna values by adjusting phases of the plurality of second-Tx-based virtual antenna values based on the one or more sets of virtual antenna values.

49. A vehicle comprising:
a system controller configured to control one or more vehicular systems of the vehicle based on radar information; and
a radar system configured to provide the radar information to the system controller, the radar system comprising:
a plurality of Transmit (Tx) antennas to transmit radar Tx signals;
a plurality of Receive (Rx) antennas to receive radar Rx signals based on the radar Tx signals; and
a processor configured to:
process Range-Doppler (RD) information corresponding to an RD bin to identify one or more sets of virtual antenna values corresponding to one or more sets of overlapping virtual antennas, respectively, wherein a set of virtual antenna values corresponding to a set of overlapping virtual antennas comprises a first virtual antenna value corresponding to a first virtual antenna and a second virtual antenna value corresponding to a second virtual antenna, the first virtual antenna based on a combination of a first Tx antenna and a first Rx antenna, the second virtual antenna based on a combination of a second Tx antenna and a second Rx antenna; and
determine a plurality of adjusted virtual antenna values by adjusting a plurality of second-Tx-based virtual antenna values based on the one or more sets of virtual antenna values, the plurality of second-Tx-based virtual antenna values corresponding to a plurality of second-Tx virtual antennas, which are based on the second Tx antenna; and
output processed data based on the plurality of adjusted virtual antenna values, wherein the radar information is based on the processed data.

50. The vehicle of claim 49, wherein the processor is configured to determine a phase shift corresponding to the second Tx antenna based on the one or more sets of virtual antenna values, and to determine the plurality of adjusted virtual antenna values by adjusting phases of the plurality of second-Tx-based phase values based on the phase shift corresponding to the second Tx antenna.
